(19) United States
(12) Patent Application Publication
(10) Pub. No.: US 2025/0159079 A1
(43) Pub. Date: May 15, 2025

(54) SYSTEM AND METHOD FOR CONVERSION OF REAL-TIME VOICE LOGS TO USER INTERFACE LOGS FOR DEBUGGING OF INTERACTIVE VOICE RESPONSE INTERACTIONS

(71) Applicant: BANK OF AMERICA CORPORATION, Charlotte, NC (US)

(72) Inventors: Sushama Shelke, Mumbai (IN); Nipun Mahajan, Lawrenceville, NJ (US); Amit Mishra, Chennai (IN); Piyush Sharma, Ambala (IN)

(73) Assignee: BANK OF AMERICA CORPORATION, Charlotte, NC (US)

(21) Appl. No.: 18/389,385

(22) Filed: Nov. 14, 2023

(51) Int. Cl. H04M 3/493; G10L 15/26

(52) U.S. Cl. CPC H04M 3/493; G10L 15/26

(57) ABSTRACT

Embodiments of the present invention provide a system for conversion of real-time voice logs to user interface logs for debugging of Interactive Voice Response (IVR) interactions. The system is configured for determining that a user has initiated a real-time voice interaction with a voice interaction processing platform, generating a real-time voice log associated with the real-time voice interaction, parsing the real-time voice log, via a real-time parser, converting, in real-time via a real-time converter, the parsed voice log to a real-time user interface log, generating a real-time user interface comprising the real-time user interface log, and displaying the real-time user interface comprising the real-time user interface log to the user for debugging the real-time voice interaction.

### BACKGROUND

There exists a need for a system for conversion of real-time voice logs to user interface logs for debugging of Interactive Voice Response (IVR) interactions.

### BRIEF SUMMARY

Embodiments of the present invention address the above needs and/or achieve other advantages by providing apparatuses (e.g., a system, computer program product and/or other devices) and methods for conversion of real-time voice logs to user interface logs for debugging of Interactive Voice Response (IVR) interactions. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention determines that a user has initiated a real-time voice interaction with a voice interaction processing platform, generates a real-time voice log associated with the real-time voice interaction, parses the real-time voice log, via a real-time parser, converts, in real-time via a real-time converter, the parsed voice log to a real-time user interface log, generates a real-time user interface comprising the real-time user interface log, and displays the real-time user interface comprising the real-time user interface log to the user for debugging the real-time voice interaction.

In some embodiments, the present invention automatically identifies, via an artificial intelligence engine, an error associated with the real-time voice interaction, generates one or more recommendations, via the artificial intelligence engine; and displays the error and the one or more recommendations in the real-time user interface log.

In some embodiments, the present invention identifies a role associated with the user, determines a type of the role, and generates the real-time user interface based on the type of the role associated with the user.

In some embodiments, the present invention identifies unique identification information provided by the user during the during the real-time voice interaction and masks the unique identification information associated with the user provided during the real-time voice interaction

In some embodiments, the real-time voice interaction is associated with a first voice flow.

In some embodiments, the present invention allows the user to initiate a second voice flow after completion of the first voice flow during the real-time voice interaction.

In some embodiments, the present invention generates a real-time utterance transcription associated with the real-time voice interaction.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for conversion of real-time voice logs to user interface logs for debugging of Interactive Voice Response (IVR) interactions, in accordance with an embodiment of the invention;

FIG. 2 provides a block diagram illustrating the entity system 200 of FIG. 1, in accordance with an embodiment of the invention;

FIG. 3 provides a block diagram illustrating a real-time voice log conversion system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for conversion of real-time voice logs to user interface logs for debugging of Interactive Voice Response (IVR) interactions, in accordance with an embodiment of the invention;

FIG. 6 provides a block diagram illustrating the process of conversion of real-time voice logs to user interface logs for debugging of Interactive Voice Response (IVR) interactions, in accordance with an embodiment of the invention; and

FIG. 7 provides a real-time conversion user interface generated by the real-time voice log conversion system 300, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that develops, provides, utilizes, tests, and/or deploys an Interactive Voice Response platform/system to one or more end users (e.g., customers, potential customers, employees, contractors, and/or the like) of the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications, systems, servers, and/or devices provided by the entity and/or the system of the present invention. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Interactive Voice Response (IVR) platforms may be provided by an entity to one or more end users (e.g., customers, potential customers, employees, or the like). IVR platforms are automated systems that provide information to incoming callers. Such IVR platforms may be developed by an entity and during the development, testing, and deployment phases of the IVR platform, users (e.g., application developers, application testers, application designer, or the like) may face difficulty to test functionalities of the IVR platform that are being developed/tested/deployed. Users typically have to call the IVR system to test every single functionality, complete the call, and then wait for the voice log to be generated before initiating the process of debugging. After performing debugging and potentially fixing the functionality, the user has to restart the IVR platform server and start the testing process all over again, thereby reducing the overall efficiency of the process and increasing consumption of processing power of IVR servers for multiple voice log generation and restart of the IVR platform server. As such, there exists a need for system to overcome these difficulties and provide a solution for converting real-time voice logs to user interface logs for debugging of Interactive Voice Response (IVR) interactions in real-time.

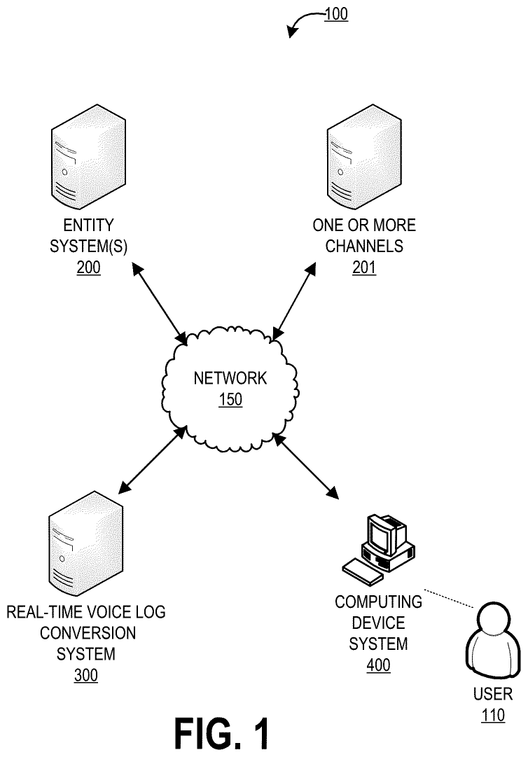

FIG. 1 provides a block diagram illustrating a system environment 100 for conversion of real-time voice logs to user interface logs for debugging of Interactive Voice Response (IVR) interactions, in accordance with an embodiment of the invention. As illustrated in FIG. 1, the environment 100 includes a real-time voice log conversion system 300, entity system 200, one or more channels 201, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200. In some embodiments, the one or more user(s) 110 of the system environment 100 may be customers of the entity associated with the entity system 200. In some embodiments, the one or more user(s) 110 of the system environment 100 may be potential customers of the entity associated with the entity system 200.

The entity system(s) 200 may be any system owned or otherwise controlled by an entity to support or perform one or more process steps described herein. In some embodiments, the entity is a financial institution. In some embodiments, the entity is a non-financial institution. The one or more channels may be any channels (e.g., web, call, mobile application, or the like) provided by the entity to end users (e.g., customers) for accessing an IVR platform provided by the entity.

The real-time voice log conversion system 300 is a system of the present invention for performing one or more process steps described herein. In some embodiments, the real-time voice log conversion system 300 may be an independent system. In some embodiments, the real-time voice log conversion system 300 may be a part of the entity system 200.

The real-time voice log conversion system 300, the entity system 200, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the real-time voice log conversion system 300 is configured to communicate information or instructions with the entity system 200, and/or the computing device system 400 across the network 150.

The computing device system 400 may be a computing device of the user 110. In general, the computing device system 400 communicates with the user 110 via a user interface of the computing device system 400, and in turn is configured to communicate information or instructions with the real-time voice log conversion system 300 and/or entity system 200 across the network 150.

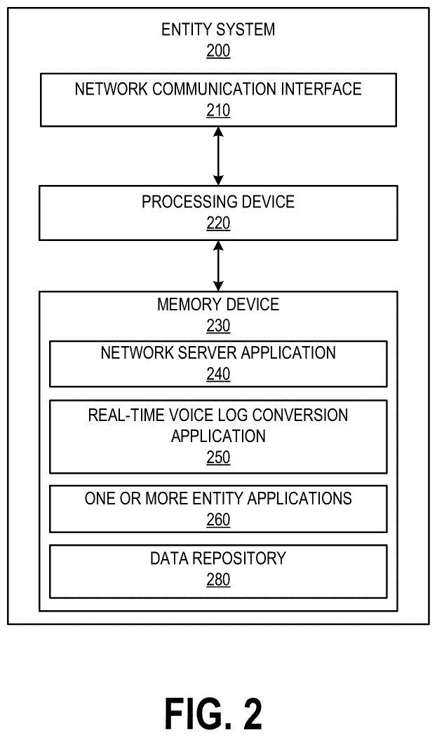

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by an entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a real-time voice log conversion application 250, one or more entity applications 260, and a data repository 280. The computer-executable program code of the network server application 240, the real-time voice log conversion application 250, and the one or more entity applications 260 to perform certain logic, data-extraction, and data-storing functions of the entity system 200 described herein, as well as communication functions of the entity system 200.

The network server application 240, the real-time voice log conversion application 250, and the one or more entity applications 260 are configured to store data in the data repository 280 or to use the data stored in the data repository 280 when communicating through the network communication interface 210 with the real-time voice log conversion system 300, and the computing device system 400 to perform one or more process steps described herein. In some embodiments, the entity system 200 may receive instructions from the real-time voice log conversion system 300 via the real-time voice log conversion application 250 to perform certain operations. The real-time voice log conversion application 250 may be provided by the real-time voice log conversion system 300.

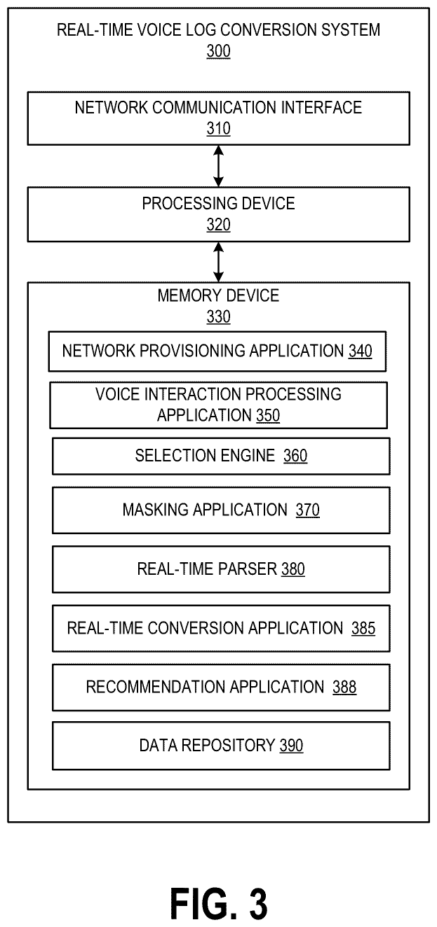

FIG. 3 provides a block diagram illustrating the real-time voice log conversion system 300 in greater detail, in accordance with embodiments of the invention. As illustrated in FIG. 3, in one embodiment of the invention, the real-time voice log conversion system 300 includes one or more processing devices 320 operatively coupled to a network communication interface 310 and a memory device 330. In certain embodiments, the real-time voice log conversion system 300 is operated by an entity, such as a financial institution, while in other embodiments, the real-time voice log conversion system 300 is operated by an entity other than a financial institution. In some embodiments, the real-time voice log conversion system 300 is owned or operated by the entity of the entity system 200. In some embodiments, the real-time voice log conversion system 300 may be an independent system. In alternate embodiments, the real-time voice log conversion system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the real-time voice log conversion system 300 described herein. For example, in one embodiment of the real-time voice log conversion system 300, the memory device 330 includes, but is not limited to, a voice interaction processing application 350, a selection engine 360, a masking application 370, a real-time parser 380, a real-time conversion application 385, a recommendation application 388, and a data repository 390 comprising data processed or accessed by one or more applications in the memory device 330. The computer-executable program code of the network provisioning application 340, the voice interaction processing application 350, the selection engine 360, the masking application 370, the real-time parser 380, the real-time conversion application 385, and the recommendation application 388 may instruct the processing device 320 to perform certain logic, data-processing, and data-storing functions of the real-time voice log conversion system 300 described herein, as well as communication functions of the real-time voice log conversion system 300.

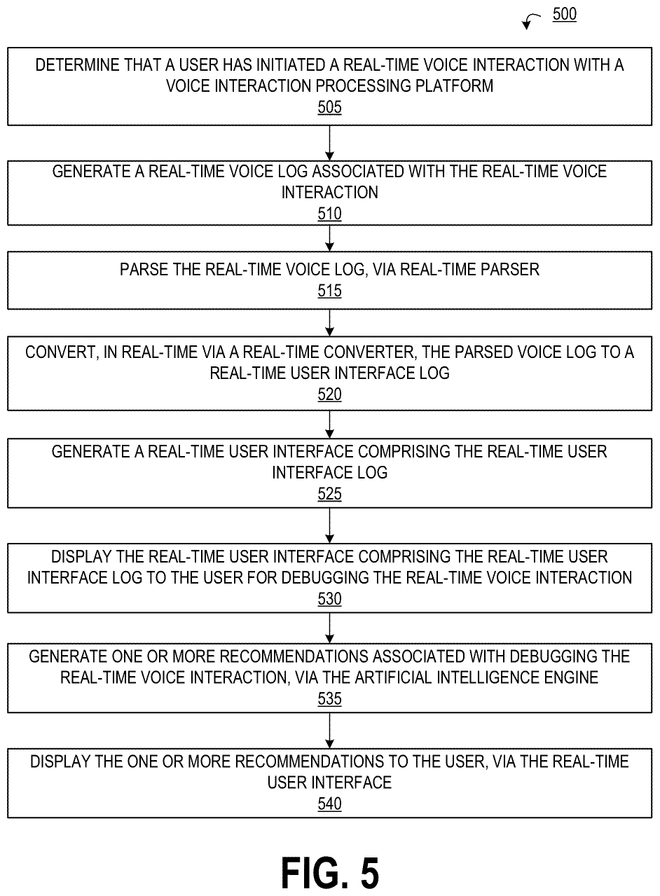

The network provisioning application 340, the voice interaction processing application 350, the selection engine 360, the masking application 370, the real-time parser 380, the real-time conversion application 385, and the recommendation application 388 are configured to invoke or use the data in the data repository 390 when communicating through the network communication interface 310 with the entity system 200, and the computing device system 400. In some embodiments, the network provisioning application 340, the voice interaction processing application 350, the selection engine 360, the masking application 370, the real-time parser 380, the real-time conversion application 385, and the recommendation application 388 may store the data extracted or received from the entity system 200 and the computing device system 400 in the data repository 390. In some embodiments, the network provisioning application 340, the voice interaction processing application 350, the selection engine 360, the masking application 370, the real-time parser 380, the real-time conversion application 385, and the recommendation application 388 may be a part of a single application. One or more processes performed by the network provisioning application 340, the voice interaction processing application 350, the selection engine 360, the masking application 370, the real-time parser 380, the real-time conversion application 385, and the recommendation application 388 are described in FIGS. 5 through 7.

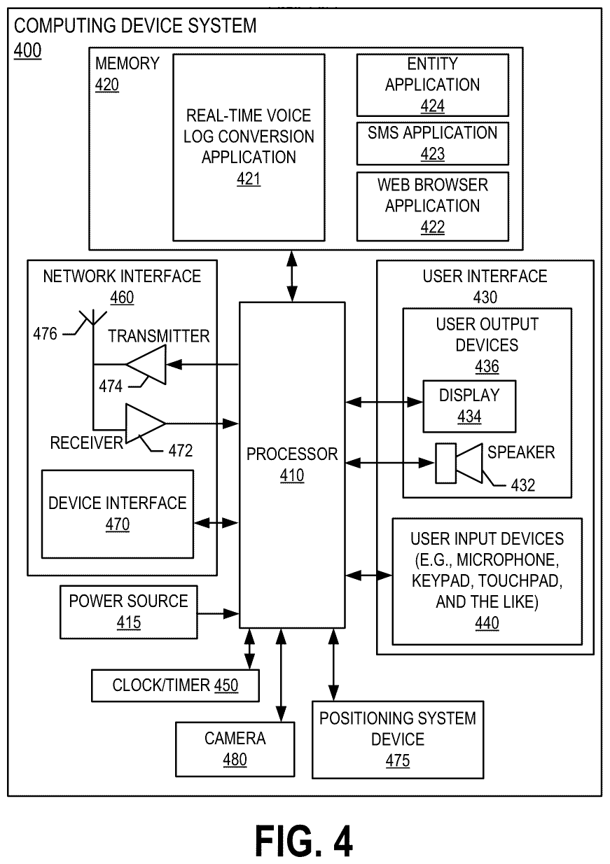

FIG. 4 provides a block diagram illustrating a computing device system 400 of FIG. 1 in more detail, in accordance with embodiments of the invention. However, it should be understood that the computing device system 400 is merely illustrative of one type of computing device system that may benefit from, employ, or otherwise be involved with embodiments of the present invention and, therefore, should not be taken to limit the scope of embodiments of the present invention. The computing devices may include any one of portable digital assistants (PDAs), pagers, mobile televisions, mobile phone, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a real-time voice log conversion application 421, an entity application 424, or the like. These applications also typically instructions to a graphical user interface (GUI) on the display 430 that allows the user 110 to interact with the entity system 200, the real-time voice log conversion system 300, and/or other devices or systems. The memory 420 of the computing device system 400 may comprise a Short Message Service (SMS) application 423 configured to send, receive, and store data, information, communications, alerts, and the like via the wireless network 150.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a process flow for conversion of real-time voice logs to user interface logs for debugging of Interactive Voice Response (IVR) interactions in real-time, in accordance with an embodiment of the invention. As shown in block 505, the system determines that a user has initiated a real-time voice interaction with a voice interaction processing platform. The voice interaction processing platform may be any Interactive Voice Response (IVR) platform that is an automated system that provides information to incoming callers. Such IVR platforms may be developed by an entity and during the development, testing, and deployment phases of the IVR platform, users may employ the system of the present invention to test and debug one or more voice flows provided by the IVR platform. A “user” as described herein may be an employee of the entity developing, testing, deploying, and/or the like one or more functionalities associated with the IVR platform.

In one embodiment, a developer may access the voice interaction processing platform, via a user device (e.g., computing device system 400) and may initiate a voice flow associated with a functionality provided by the voice interaction processing platform. For example, the voice interaction processing platform may be associated with a financial institution and the developer developing a payment information functionality associated with the voice interaction processing platform may initiate an interaction to initiate a voice flow associated with the payment information functionality to debug the code associated with the payment information functionality.

As shown in block 510, the system generates a real-time voice log associated with the real-time voice interaction. The real-time voice log may be a Voice Extensible Markup Language (VXML) log file, where the real-time voice log comprises voice interactions between the user and the voice interaction processing platform. In some embodiments, the real-time voice log may comprise other information including, but not limited to, type of channel to initiate the interaction, user information, unique identification information (e.g., Social Security Number, username, account number, employee ID number, password, access codes, or the like), user device information associated with the user device used to initiate the interaction, inputs provided by the user during the interaction, timestamps associated with the inputs, application server, IVR server information, caller ID, and/or the like. In some embodiments, where the user provides unique identification information (e.g., Social Security Number, or the like) or any other confidential information or sensitive information, the system identifies such information and masks the unique identification information, confidential information, sensitive information, and/or the like. In some embodiments, masking of information may be based on a role associated with the user. The system identifies the role associated with the user, determines a type of the role, and performs masking based on the type of the role. For example, the system may mask personal information for all users. In another example, the system may mask access codes for testers and designers. In some embodiments, the system may also identify availability of data for the user based on the type of the role for user.

As shown in block 515, the system parses the real-time voice log, via real-time parser. Parsing the real-time voice log comprises reading and/or processing the Voice Extensible Markup Language log file generated by the system in block 510. The system may parse the real-time voice log based on the type of the role associated with the user. For example, the system may parse only a first set of information, a second set of information, and a third set of information from the real-time voice log instead of processing the entire real-time voice log based on the role of the user testing a functionality associated with the voice interaction processing platform.

As shown in block 520, the system converts, in real-time via a real-time converter, the parsed voice log to a real-time user interface log. Converting the parsed voice log to a user interface log comprises identifying at least one or more segments activated during the voice flow, utterances of the user, language information, prompts provided during the IVR response to the user, and/or the like. The system generates a user interface log displaying at least the one or more segments activated during the voice flow, the utterances provided by the user, the language information, the prompts provided during the IVR response to the user, and/or the like. In some embodiments, the one or more segments are displayed in the form of program code. In some embodiments, the one or more segments are displayed in the form of user interface (UI) elements that represent the voice flow based on the inputs provided by the user. In some embodiments, the one or more segments are displayed in the form of a table.

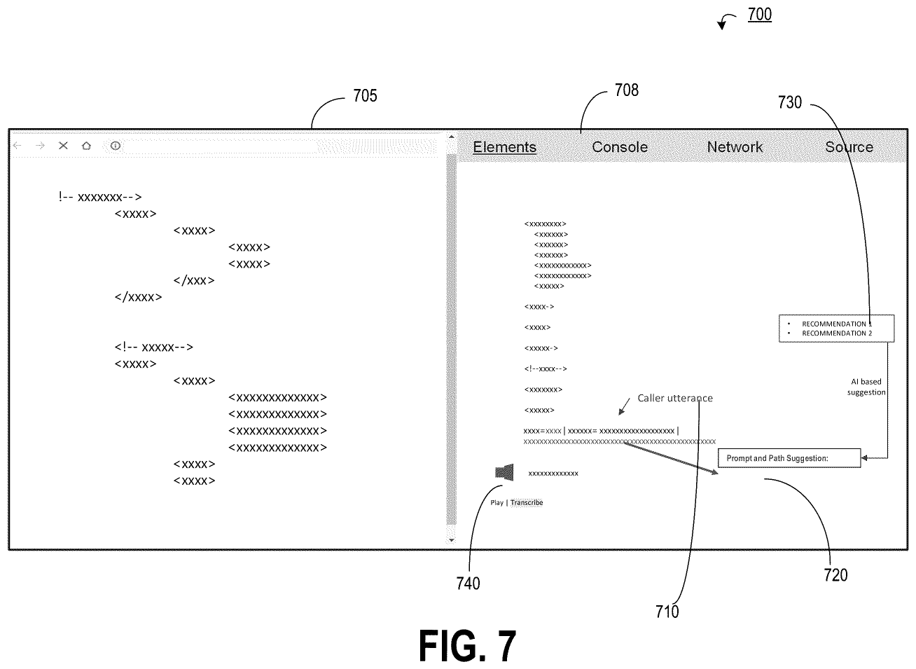

As shown in block 525, the system generates a real-time user interface comprising the real-time user interface log. In some embodiments, the system may also display the other information captured by the system including, but not limited to, type of channel to initiate the interaction, user information, user device information associated with the user device used to initiate the interaction, inputs provided by the user during the interaction, timestamps associated with the inputs, and/or the like. An example of the real-time user interface generated by the system is shown in FIG. 7. The generation of real-time user interface comprising the real-time user interface log is instantaneous and in real-time as the user is interacting with the voice interaction processing platform.

As shown in block 530, the system displays the real-time user interface comprising the real-time user interface log to the user for debugging the real-time voice interaction. In some embodiments, the system may display a modified real-time user interface to each user viewing the real-time user interface for debugging the real-time voice interaction. In some embodiments, the system identifies the role associated with the user, determines the type of the role, and generates the real-time user interface based on the type of the role associated with the user. For example, the system may determine, based on the unique user identification information provided by the user during the real-time voice interaction, that the user is an application developer, and may instantaneously modify the real-time user interface to create a custom user interface for application developers, wherein information displayed on the real-time user interface may comprise server ID, application server, IVR server information, version, logger statements call ID, Dialogue nodes, session ID, runtime errors, and/or the like. In another example, the system may determine, based on the unique user identification information provided by the user during the real-time voice interaction, that the user is an application designer, and may instantaneously modify the real-time user interface to create a custom user interface for application designers, wherein information displayed on the real-time user interface may comprise dialogue nodes, utterance ID, utterance, server name, call ID, language details, and/or the like. For example, the system may determine, based on the unique user identification information provided by the user during the real-time voice interaction, that the user is an application tester, and may instantaneously modify the real-time user interface to create a custom user interface for application testers, wherein information displayed on the real-time user interface may comprise call ID, call nodes, logging statements, prompts wording, dialogue nodes, application errors, and/or the like. In some embodiments, the system may generate a real-time utterance transcription associated with the real-time voice interaction and display the real-time utterance transcription in the real-time user interface.

In some embodiments, the system comprises an artificial intelligence engine that analyzes the real-time user interface log and the real-time voice logs and debugs the voice flow associated with the real-time voice interaction to identify one or more errors. Upon identification of the errors, the system may generate one or more remediation steps and/or recommendations to fix the errors or to improve the voice flow associated with the real-time voice interaction as shown in block 535. For example, if the user initiated a voice flow associated with payment information and the platform provided IVR response associated with account balance, the system identifies such a response as an error, via an artificial intelligence engine, and provides a remediation step to automatically correct the program code by replacing account balance IVR response linked with the payment information tag with a payment information IVR response. It should be understood that the examples provided herein are for explanatory purposes only and do not delineate the scope of the invention. As such, the process flow described herein may be applied to any non-financial IVR systems.

As shown in block 540, the system displays the one or more recommendations to the user, via the real-time user interface. In some embodiments, the system may also provide a single-click mechanism to automatically correct the error based on the one or more recommendations, where the single click mechanism comprises one or more code changes in the program code associated with the voice flow that the user is testing. In some embodiments, the system allows the user to test a second voice flow during the real-time voice interaction initiated by the user.

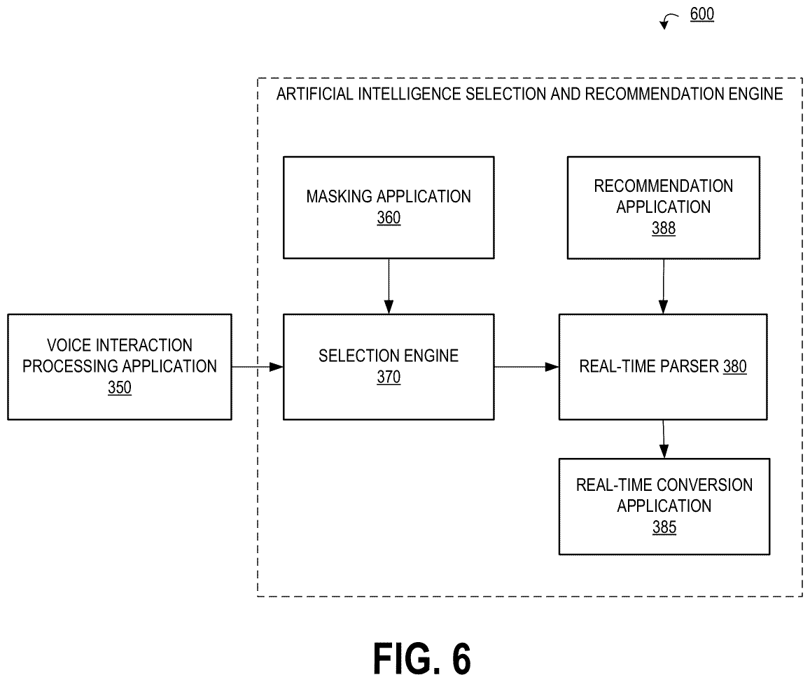

FIG. 6 provides a block diagram illustrating the process of conversion of real-time voice logs to user interface logs for debugging of Interactive Voice Response (IVR) interactions, in accordance with an embodiment of the invention. As shown, the voice interaction processing platform 350 receives an initiation of real-time voice interaction from a user (e.g., application developer, application designer, application tester, or the like) to test a voice flow associated with a functionality provided by the voice interaction processing platform 350. As shown, the masking application 360, the selection application 370, the recommendation application 388, the real-time parser 380, and the real-time conversion application 385 may be a part of an artificial intelligence selection and recommendation engine provided by the system of the present invention. During the real-time voice interaction, the user may provide information such as unique identification information, sensitive information, confidential information, and/or the like to the system and the masking application 360 may mask such unique identification information, sensitive information, confidential information, and/or the like. The selection engine 370 may select one or more parameters for processing the real-time voice interaction, where the one or more parameters may be based on the role of the user and the type of the role of the user. Based on the one or more parameters, the real-time parser 380 parses the real-time voice interaction and passes it to the real-time conversion application 385, where the real-time voice interaction is converted into a real-time UI log as explained in FIG. 5 and is displayed to the user for debugging, via a real-time user interface generated by the system. The recommendation application 388 may automatically debug the real-time voice interaction in real-time and may provide one or more recommendations to correct any errors identified during the debugging process.

FIG. 7 provides a real-time conversion user interface generated by the real-time voice log conversion system 300, in accordance with an embodiment of the invention. As shown, one or more program codes associated the one or more segments of a voice flow activated during the real-time voice interaction by the user is displayed as shown in reference 705. The system may also allow the user to inspect one or more elements of the one or more program codes as shown in reference 708. In some embodiments, the system may automatically debug the one or more program codes during the real-time voice interaction and may identify one or more errors and highlight the one or more errors for the user as shown in reference 710, where one or more utterances in the voice flow associated with the one or more errors may also be highlighted. The system may then generate one or more recommendations as shown in reference 730 and generate one or more code changes to correct the one or more program codes as shown in reference 720. The system may also allow the user to play audio associated with the real-time voice interaction as shown in reference 740.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for conversion of real-time voice logs to user interface logs for debugging of Interactive Voice Response (IVR) interactions, comprising:
at least one processing device;
at least one memory device; and
a module stored in the at least one memory device comprising executable instructions that when executed by the at least one processing device, cause the at least one processing device to:
determine that a user has initiated a real-time voice interaction with a voice interaction processing platform;
generate a real-time voice log associated with the real-time voice interaction;
parse the real-time voice log, via a real-time parser;
convert, in real-time via a real-time converter, the parsed voice log to a real-time user interface log;
generate a real-time user interface comprising the real-time user interface log; and
display the real-time user interface comprising the real-time user interface log to the user for debugging the real-time voice interaction.

2. The system according to claim 1, wherein the executable instructions cause the at least one processing device to:
automatically identify, via an artificial intelligence engine, an error associated with the real-time voice interaction;
generate one or more recommendations, via the artificial intelligence engine; and
display the error and the one or more recommendations in the real-time user interface log.

3. The system according to claim 1, wherein the executable instructions cause the at least one processing device to:
identify a role associated with the user;
determine a type of the role; and
generate the real-time user interface based on the type of the role associated with the user.

4. The system according to claim 1, wherein the executable instructions cause the at least one processing device to:
identify unique identification information provided by the user during the during the real-time voice interaction; and
mask the unique identification information associated with the user provided during the real-time voice interaction.

5. The system according to claim 1, wherein the real-time voice interaction is associated with a first voice flow.

6. The system according to claim 5, wherein the executable instructions cause the at least one processing device to allow the user to initiate a second voice flow after completion of the first voice flow during the real-time voice interaction.

7. The system according to claim 1, wherein the executable instructions cause the at least one processing device to generate a real-time utterance transcription associated with the real-time voice interaction.

8. A computer program product for conversion of real-time voice logs to user interface logs for debugging of Interactive Voice Response (IVR) interactions, comprising a non-transitory computer-readable storage medium having computer-executable instructions for:
determining that a user has initiated a real-time voice interaction with a voice interaction processing platform;
generating a real-time voice log associated with the real-time voice interaction;
parsing the real-time voice log, via a real-time parser;
converting, in real-time via a real-time converter, the parsed voice log to a real-time user interface log;
generating a real-time user interface comprising the real-time user interface log; and
displaying the real-time user interface comprising the real-time user interface log to the user for debugging the real-time voice interaction.

9. The computer program product according to claim 8, wherein the non-transitory computer-readable storage medium comprises computer-executable instructions for:
automatically identifying, via an artificial intelligence engine, an error associated with the real-time voice interaction;
generating one or more recommendations, via the artificial intelligence engine; and
displaying the error and the one or more recommendations in the real-time user interface log.

10. The computer program product according to claim 8, wherein the non-transitory computer-readable storage medium comprises computer-executable instructions for:
identify a role associated with the user;
determine a type of the role; and
generate the real-time user interface based on the type of the role associated with the user.

11. The computer program product according to claim 8, wherein the non-transitory computer-readable storage medium comprises computer-executable instructions for:
identifying unique identification information provided by the user during the during the real-time voice interaction; and
masking the unique identification information associated with the user provided during the real-time voice interaction.

12. The computer program product according to claim 8, wherein the real-time voice interaction is associated with a first voice flow.

13. The computer program product according to claim 12, wherein the non-transitory computer-readable storage medium comprises computer-executable instructions for allowing the user to initiate a second voice flow after completion of the first voice flow during the real-time voice interaction.

14. The computer program product according to claim 8, wherein the non-transitory computer-readable storage medium comprises computer-executable instructions for generating a real-time utterance transcription associated with the real-time voice interaction.

15. A computerized method for conversion of real-time voice logs to user interface logs for debugging of Interactive Voice Response (IVR) interactions, the method comprising:
determining that a user has initiated a real-time voice interaction with a voice interaction processing platform;
generating a real-time voice log associated with the real-time voice interaction;
parsing the real-time voice log, via a real-time parser;
converting, in real-time via a real-time converter, the parsed voice log to a real-time user interface log;
generating a real-time user interface comprising the real-time user interface log; and
displaying the real-time user interface comprising the real-time user interface log to the user for debugging the real-time voice interaction.

16. The computerized method according to claim 15, wherein the method comprises
automatically identifying, via an artificial intelligence engine, an error associated with the real-time voice interaction;
generating one or more recommendations, via the artificial intelligence engine; and
displaying the error and the one or more recommendations in the real-time user interface log.

17. The computerized method according to claim 16, wherein the method comprises
identify a role associated with the user;
determine a type of the role; and
generate the real-time user interface based on the type of the role associated with the user.

18. The computerized method according to claim 16, wherein the method comprises
identifying unique identification information provided by the user during the during the real-time voice interaction; and
masking the unique identification information associated with the user provided during the real-time voice interaction.

19. The computerized method according to claim 15, wherein the real-time voice interaction is associated with a first voice flow.

20. The computerized method according to claim 19, wherein the method comprises allowing the user to initiate a second voice flow after completion of the first voice flow during the real-time voice interaction.
